(19) United States
(12) Patent Application Publication
(10) Pub. No.: US 2014/0241618 A1
(43) Pub. Date: Aug. 28, 2014

(54) Combining Region Based Image Classifiers

(71) Applicant: HEWLETT-PACKARD DEVELOPMENT COMPANY, L.P., (US)

(72) Inventors: Steven J. Simske, Fort Collins, CO (US); Malgorzata M. Sturgill, Fort Collins, CO (US); Matthew D. Gaubatz, Bellevue, WA (US); Paul S. Everest, Corvallis, OR (US); Masoud Zaverehi, Corvallis, OR (US)

(73) Assignee: HEWLETT-PACKARD DEVELOPMENT COMPANY, L.P., Houston, TX (US)

(21) Appl. No.: 13/780,330

(22) Filed: Feb. 28, 2013

(51) Int. Cl. G06K 9/62

(52) U.S. Cl. CPC G06K 9/6217
USPC 382/159

(57) ABSTRACT

Examples disclosed herein relate to combining region based image classifiers. In one implementation, a processor measures correct classification and misclassification levels associated with a first image classifier related to a first image feature region and measures correct classification and misclassification levels associated with a second image classifier related to a second image feature region. The processor may create a combined classifier based on the first image classifier correct classification and misclassification levels and based on the second image classifier correct classification and misclassification levels such that the combined classifier is related to the first image feature region and the second image feature region.

### BACKGROUND

Image classification methods may be used to automatically categorize images into different classes based on machine learning techniques. For example, a binary classifier may be used to classify an image between classes according to features of the image.

### BRIEF DESCRIPTION OF THE DRAWINGS

The drawings describe example embodiments. The following detailed description references the drawings, wherein:

FIG. 1 is a block diagram illustrating one example of an apparatus to combine region based image classifiers.

FIG. 2 is a flow chart illustrating one example of a method to combine region based image classifiers.

FIG. 3 is a block diagram illustrating one example of combining region based image classifiers.

FIG. 4 is a flow chart illustrating one example of using a region based image classifier.

### DETAILED DESCRIPTION

An image classifier method may be used to automatically assign images to categories. In one implementation, a processor creates an image classifier based on classifying images according to a particular type of image region. An image region may be, for example, image content including, but not limited to, image data containing a certain type of content, such as a barcode, or image data corresponding to a particular area at a certain location within an image, such as the top-left corner, or a combination thereof, such as a barcode in the top-left corner. Image classifiers based on different regions may be combined where each of the image classifiers is weighted such that a higher weighted image classifier is given more importance than a lower weighted image classifier. The weights may be determined based on the ability of the image classifier to assign training data to the correct classes. In one implementation, a confusion matrix for showing confusion between actual and assigned classes of training data is created and displayed to a user such that a user may adjust the weights or the methods for determining the weights based on an analysis of the confusion matrix. A region based classifier may allow a classifier to classify an image based on a smaller portion of the image data, and the region based classifiers may be combined in different manners to produce a classifier with optimal results.

Classifying images may be used for various purposes. In some cases, a region based image classifier may be used to identify counterfeiting. For example, a product image, such as packaging, may be associated with a particular print service provider or set of print service providers for printing the image in the legitimate supply chain. The classifier may be applied to the image to determine if the image is printed by a print service provider associated with the legitimate supply chain. If the classifier assigns the image to the class associated with a different print service provider or to the legitimate print service provider with a lower than acceptable confidence, then counterfeiting may be suspected. In another implementation, a region based classifier may be used to determine the quality of an image associated with a print service provider. For example, a low confidence level associated with assigning the image to the originating print service provider may indicate a low quality image, indicating that the image fails quality inspection.

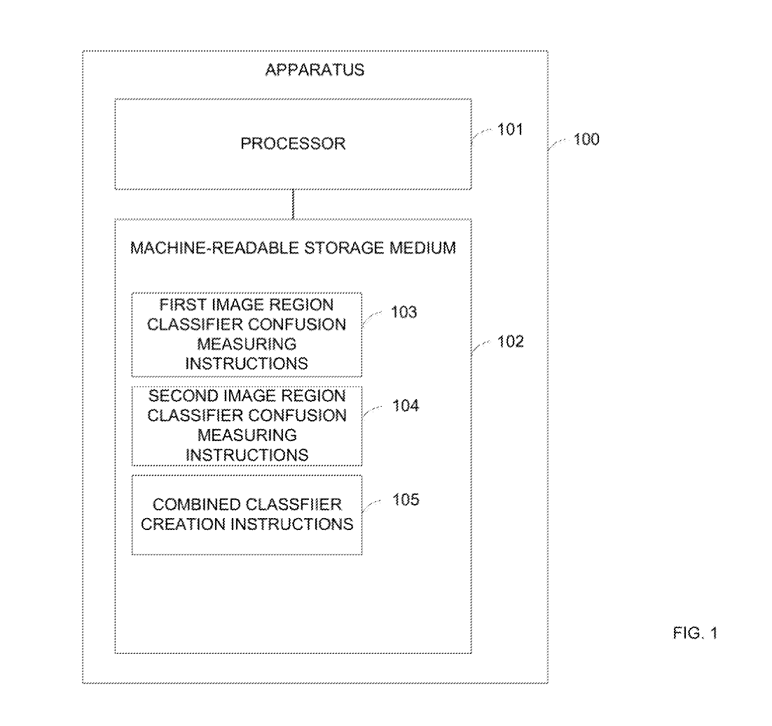

FIG. 1 is a block diagram illustrating one example of an apparatus 100 to combine region based image classifiers. The apparatus 100 may create an image classifier to classify images based on a first and second image region from two separate image classifiers where the first image classifier classifies images based on the first image region and the second image classifier classifies images based on the second image region.

The apparatus 100 may be a computer, such as a laptop. In one implementation, the apparatus 100 is a server that receives images for classification via a network. For example, a cloud based service may be provided for classifying images based on different image region types. The apparatus 100 may include, for example, a processor 101 and a machine-readable storage medium 102.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 102. The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include first image region classifier misclassification measuring instructions 103, second image region classifier misclassification measuring instructions 104, and combined classifier creation instructions 105.

The first image region classifier misclassification measuring instructions 103 may measure inaccuracy that includes misclassification between actual and assigned classes. The first image region classifier may be any suitable classifier, such as a binary classifier. The image region may be, for example, a region of an image including a particular variable data print feature, such as a barcode.

The first image region classifier misclassification instructions 103 may be applied to a set of images with known classifications to compare to the output from the first image region classifier. The misclassification level may be measured by applying the first image region classifier to a set of images including the particular image region and comparing the assigned classes from the classifier to the actual classes to which the images belong. For example, the misclassification may measure where an image is part of class A but assigned to class B. The misclassification level may be measured on its own, in conjunction with a measurement of correctly assigned classes, or as an inverse of correctly assigned classes. The misclassification measuring instructions 103 may measure the recall and precision of the classifier. For example, the recall may indicate the proportion of images that belong to a particular image class that were assigned to that image class, and the precision may indicate the proportion of images assigned to their actual image class that were correctly classified. The accuracy of the classifier may be determined based on the recall and precision. For example, the accuracy of the classifier may be defined as the harmonic mean of recall and precision, determined as (2*recall*precision (recall+precision)). The misclassification measuring instructions 103 may measure a number of misclassifications and the class to which an image was misclassified.

The second image region classifier misclassification measuring instructions 104 may measure inaccuracy from misclassification between actual and assigned classes for the second classifier for classifying the images based on the second image region. For example, the recall, accuracy, and precision levels associated with the different classes may be determined after the second image region classifier is applied to the same set of images classified using the first image region classifier.

The combined classifier creation instructions 105 may include instructions to create an image classifier to classify images based on both the first image region and the second image region based on the misclassification information associated with each of the classifiers. For example, the two individual classifiers may be mathematically combined without training a new machine learning classifier to classify images based on the multiple image regions.

The two classifiers may be weighted based on the misclassification measurement associated with each, and the classifiers may be combined using the weights. For example, a method may be used to determine how to proportion weight between the two classifiers such that a more accurate and/or precise classifier is given more weight. A new single classifier may be created to classify images based on the first and second image regions by combining the first and second image classifiers according to the determined weights.

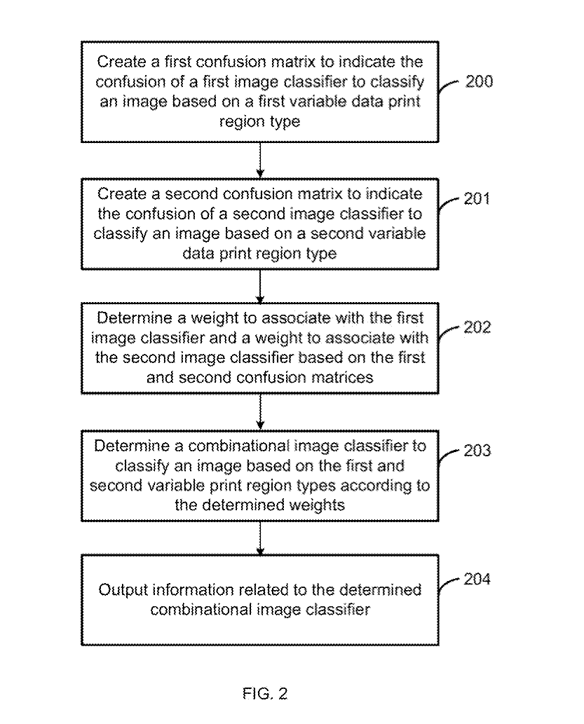

FIG. 2 is a flow chart illustrating one example of a method to combine region based image classifiers. For example, two separate region based classifiers may be used where the first classifier classifies images based on a first image region type, and a second classifier classifies images based on a second image region type. A third classifier may be created by weighting the two classifiers such that the third classifier accounts for both the first and second region types. In some cases, the third classifier may be more accurate than a classifier categorizing images based on the first or the second image region type. The method may be implemented, for example, by the apparatus 100 of FIG. 1.

Beginning at 200, a processor creates a first confusion matrix to indicate the confusion of a first image classifier to classify an image based on a first variable data print region type. The confusion matrix may be any suitable matrix for displaying confusion between classes when applying a particular classifier. For example, the confusion matrix may display a measure of inaccuracy by showing misclassifications between actual classifications and assigned classifications by the classifier and/or a measure of accuracy by showing correct classifications between actual classifications and assigned classifications. The confusion matrix may be displayed on a display associated with a user device such that a user may analyze the created matrix.

The data variable print region print type may be any suitable data variable print type, such as a barcode, guilloche, 3D color tile, or photograph regions. The classifier may be any suitable classifier for classifying images. In one implementation, the classifier is a binary classifier. The classifier may take into account any suitable image features, such as entropy, mean intensity, image percent edges, mean edge magnitude, pixel variance, mean-region size intensity-based segmentation, region-size variance intensity-based segmentation, mean image saturation, mean region size saturation-based segmentation, and region size variance intensity-based segmentation.

In one implementation, the classifier is applied to the particular region on a training set of images with known classifications. In some cases, the images may be from a particular set of print service providers, and the classifier may classify the images between the print service providers in the set.

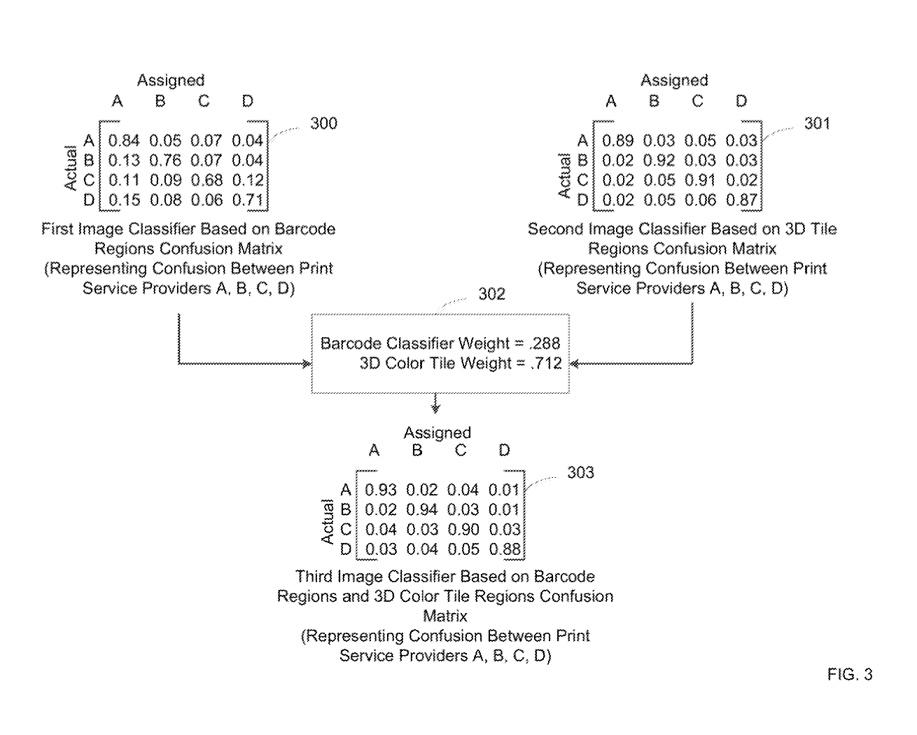

FIG. 3 provides an example of a first confusion matrix. FIG. 3 is a block diagram illustrating one example of combining region based image classifiers. Confusion matrix 300 shows levels of confusion when classifying images between print service providers A, B, C, and D based on barcode image regions. Along the x-axis, the print service providers represent the assigned classes from the classifier, and along the y-axis the print service providers represent the actual classes. For example, for images from print service provider A, 84% were assigned correctly to print service provider A, 5% were assigned incorrectly to print service provider B, 7% were assigned incorrectly to print service provider C, and 4% were incorrectly assigned to print service provider D. The second line of the matrix displays the confusion associated with images that should have been assigned to print service provider B, the third line of the matrix displays the confusion associated with images that should have been assigned to print service provider C, and the fourth line of the matrix displays confusion associated with images that should have been assigned to print service provider D.

In one implementation, a processor measures the accuracy and precision of a classifier based on the confusion matrix or based on the data from the confusion matrix in a different format. For example, for matrix 300, the accuracy may be determined by averaging the downward left to right diagonal, resulting in an accuracy level for the barcode classifier of 0.748. The precision of the classifier may be determined for each element by the number correctly identified for a class divided by the total number identified for the class. For example, the precision for print service provider A may be determined by: 0.84/(0.84+0.13+0.11+0.15)=0.683. The precision, recall, and accuracy information may be used to evaluate the classifier. (In this case, the mean accuracy and mean recall is the same.)

Referring back to FIG. 2 and continuing to 201, a processor creates a second confusion matrix to indicate the confusion of a second image classifier to classify an image based on a second variable data print region type. The second confusion matrix may be a matrix created in the same manner as the first confusion matrix where the second image classifier is applied. The second image classifier may take into account one or more regions different than the first image classifier. The second image classifier may use the same underlying method as the first image classifier, such as where both are binary classifiers. The second variable data print region type may be, for example, a barcode, guilloche, 3D color tile, or photograph.

The classifier may be applied to the particular region on a training set of images. The training set of images may be the same images used by the first image classifier where the images contain both image features, or the training set may be a different set of training images. The images may be from the same set of print service providers as used to create the first confusion matrix, and the classifier may classify the images between the print service providers in the set based on the second region type.

The first and/or second confusion matrices may be caused to be displayed to a user. The user may view information about the classifiers, such as accuracy and precision of the two different classifiers, by analyzing the matrices.

Referring to the example in FIG. 3, Confusion matrix 301 shows confusion when classifying images between print service providers A, B, C, and D based on 3D color tile regions in the images. The data used to create matrix 301 may be the same data used to create matrix 300. For example, the images may include both features.

Confusion matrix 301 shows that the classifier based on 3D color tiles is more accurate than that based on barcodes for each of the four print service providers. For example, 89% are correctly classified to print service provider A, 92% are correctly classified to print service provider B, 91% are correctly classified to print service provider C, and 87% are correctly classified to print service provider D. The accuracy of the classifier is 0.898, and the precision of classes A, B, C, and D is 0.937, 0.876, 0.867, and 0.916, respectively.

Referring back to FIG. 2 and proceeding to 202, a processor determines a weight to associate with the first image classifier and a weight to associate with the second image classifier based on the first and second confusion matrices. In one implementation, the weight represents a percentage value to weight each of the two classifiers such that the two weights sum to 100%. The weight may be determined in any suitable manner based on the confusion matrices. In one implementation, the accuracy and/or precision and/or other characteristics of the two classifiers are determined based on the confusion matrices, and the weights of the classifiers may be determined based on the characteristics.

The weights may be determined by a processor analyzing information from the confusion matrices without analyzing the confusion matrices themselves. For example, the information may be stored or determined in a different manner. In one implementation, a processor displays the confusion matrices and uses the data from the matrices in or not in the matrix format to determine the characteristics for determining the weights of the classifiers.

The weights may be determined in a manner that takes into account the correct classifications and misclassifications of the two classifiers. For example, the more accurate and more precise classifier may be given a greater weight. The weights may be determined, for example, using an optimized weighting scheme or a weighting inverse of error rate scheme. An optimized weighting scheme is described, for example, in Lin, X., Yacoub, S., Burns, J. and Simske, S. Performance analysis of pattern classifier combination by plurality voting. Pattern Recognition Letters 24, pp. 1959-1969 (2003). A weighting inverse of error rate scheme may be determined for weight W with accuracy in classification p as the following:

$${W}_{j} = \frac{1.0 / ( 1.0 - {p}_{j} )}{{\sum }_{i = 1}^{{N}_{classifiers}} 1.0 / ( 1.0 - {p}_{i} )}$$

The weighting scheme may take into account the accuracy, precision levels, and/or other characteristics evident from the confusion matrix. In one implementation, the processor does not take into account classifications where the precision level of a particular class for a classifier is below a threshold, such as below a numerical threshold. The processor may limit the determination to classifier classes to the top n classifiers in order of precision for the class. In one implementation, the processor does not consider classifiers where the accuracy of the classifier is below a threshold where more than two classifiers are being weighted. The processor may evaluate other criteria to determine whether to leave out a classifier (weight it to 0) based on the confusion matrix associated with the classifier.

Referring to the example of FIG. 3, block 302 shows weights associated with the two region based classifiers. Using a weighted inverse of the error method, the barcode classifier is weighted at 0.288, and the 3D color tile weight classifier is weighted at 0.712. The weights may be used in a combined classifier that considers both the barcode and 3D color tile regions in an image. The weighting method may be used such that a new training data set is not used to create a new classifier to classify based on the two regions.

Referring back to FIG. 2 and moving to 203, a processor determines a combinational image classifier to classify an image based on the first and second variable print region types according to the determined weights. For example, the combinational classifier may involve weighting the output of the first classifier with the weight for the first classifier and weighting the output of the second classifier with the weight of the second classifier such that the regions of both of the classifiers are taken into account in the combination.

In one implementation, more than 2 classifiers may be combined. For example, three separate classifiers may be created for regions X, Y, and Z. A fourth classifier may be created by combining the classifiers for regions X and Y. a fifth classifier may be created by combining the classifiers for regions Y and Z, and a sixth classifier may be created by combining the classifiers for regions X and Z. A seventh classifier may be created by combining the first three classifiers such that regions X, Y, and Z are taken into account. The classifiers may be created using the same type of weighting scheme used for weighting the two classifiers above.

In one implementation, a processor may use a decision tree approach to respond to classification inaccuracies revealed by the confusion matrix. For example, a region based image classifier may be selected based on superior accuracy, recall, and/or precision compared to other classifiers assigning images based on different regions. The selected image classifier may be used to disambiguate assignment groups, such as where assignment groups 1 and 2 (for example, print service providers 1 and 2) are disambiguated from assignment groups 3 and 4 by applying the selected image classifier. An image classifier assigning images based on a different combination of regions may then be applied to the cluster that includes assignment groups 1 and 2 to disambiguate assignment groups 1 and 2 from one another. The image classifiers based on different image region combinations may be applied in a decision tree manner such that together they reveal the correct assignment group for an image. The method may be valuable, for example, where the accuracy of the decision tree with combinations of regions on each node is greater than the accuracy of any of the individual classifiers based on an image region or combination of image regions.

Continuing to 204, a processor outputs information related to the determined combinational image classifier. For example, the processor may display, store, or transmit information about the combinational classifier. The processor may store information about the classifier to later retrieve the information and apply the classifier to a new data set.

In one implementation, a processor selects a classifier to be applied to a set of images. For example, a processor may create a confusion matrix related to the combinational image classifier, and the confusion matrix and/or information derived from it may be compared to the confusion matrix related to the first image classifier and the confusion matrix related to the second image classifier.

Referring to the example of FIG. 3, confusion matrix 303 shows a confusion matrix for a third classifier based on the barcode and 3D color tile classifiers. For example, the weights in block 302 may be used to combine the classifiers.

The confusion matrices may be displayed to a user, and/or information from the matrices may be output to allow selection of one or more of the classifiers. For example, the confusion matrix 303 shows that 93% of images from print service provider A were correctly assigned to print service provider A, 94% of images from print service provider B were correctly assigned to print service provider B, 90% of images from print service provider C were correctly assigned to print service provider C, and 88% of images from print service provider D were correctly assigned print service provider D. The accuracy of the classifier is 0.913, and the precision of classes A, B, C, and D are 0.912, 0.913, 0.882, and 0.946, respectively.

The processor may select one of the three classifiers to apply to a new data set based on the accuracy and/or precision of the three classifiers. For example, the most accurate classifier may be selected. In one implementation, a classifier is selected based on the visible region types of the image, such as where a more accurate classifier is not used because one of the regions analyzed by the classifier is obscured. In one implementation, the confusion matrices are displayed to a user, and a user may select which classifier to use on future data sets.

In one implementation, the processor creates a fourth classifier based on the first, second, and combinational classifier. The weight of each of the three classifiers may be determined in the same manner as for two classifiers, such as where an optimal weighting method of weighting inverse of the error rate method are applied to the confusion matrix and/or misclassification level information associated with each of the three classifiers.

In one implementation, a classifier may be created from each of the individual and combinational classifiers. For example, each classifier may be separately applied to the image, and the confidence associated with the classification from each classifier may be determined. The confidence information may output, for example, in an Output Probabilities Matrix. The Output Probabilities Matrix may be displayed to a user. The confidence values may be multiplied by the weight of the classifier and then multiplied by the precision value for the particular class and classifier. In some cases, the processor considers classifiers where the confidence level is above a threshold, such as above a percentage and/or considers the top n classifiers in order of confidence.

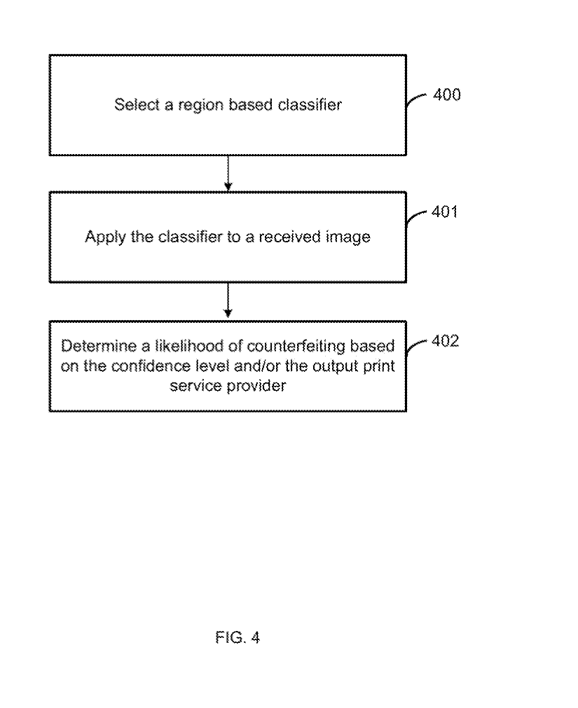

FIG. 4 is a flow chart illustrating one example of using a region based image classifier. A region based image classifier may be used, for example, in the area of security printing. The method may be implemented, for example, by the apparatus 100 of FIG. 1.

Beginning at 400, a processor selects a region based classifier. The classifier may be selected in any suitable manner. The classifier may be selected based on a comparison of the accuracy and/or precision of multiple region based classifiers. In some cases, some of the region based classifier may account for multiple region types, such as where a combinational classifier created using the method of FIG. 2 is selected. The classifier may be trained on images from a particular print service provider or on examples of the same image from multiple print service providers such that the classifier is tailored to the particular image region of the particular image.

Continuing to 401, a processor applies the selected classifier to a received image. The processor may input information about the regions of the received image that are associated with the regions of the image classifier. The received image may be, for example, packaging associated with a product. The packaging may be associated with a particular company that receives packaging from a particular print service provider or set of print service providers. The output from the selected classifier may be a print service provider, or other information indicating a source of the image.

In one implementation, the processor determines a confidence level associated with the print service provider output. For example, the classifier may output a confidence level associated with the classification to the particular print service provider, where a higher confidence level indicates a higher likelihood that the classification is correct.

Moving to 402, a processor determines a likelihood of counterfeiting based on a confidence level and/or the output print service provider. For example, the processor may evaluate the output print service provider. If the print service provider is not in the set known to create the packaging for the product owner, the processor may output information related to a likelihood of counterfeiting.

In one implementation, the processor evaluates a confidence level associated with the print service provider. For example, if a print service provider associated with the product is output, but the confidence level is below a threshold, the processor may output information indicating a likelihood of counterfeiting.

A similar method may be used to determine other information about the origin of an image. For example, packaging from a known print service provider may be classified using the selected region based image classification method. A classification to a different print service provider or a low confidence level of a classification to the correct print service provider may indicate quality problems associated with the print service provider. A region based image classifier may be easily created and compared using a confusion matrix or other methods for comparing correct classification and misclassification information. As a result, a better classifier may be used and the results from classifying new images outside of the training set are more likely to be accurate.

1. An apparatus, comprising:
a processor to:
measure correct classification and misclassification levels associated with a first image classifier related to a first image feature region;
measure correct classification and misclassification levels associated with a second image classifier related to a second image feature region; and
create a combined classifier based on the first image classifier correct classification and misclassification levels and based on the second image classifier correct classification and misclassification levels, wherein the combined classifier is related to the first image feature region and the second image feature region.

2. The apparatus of claim 1 wherein the processor is further to cause to be displayed:
a first confusion matrix associated with the first image classifier, wherein the first confusion matrix includes information about correct classification and misclassification levels associated with the first image classifier; and
a second confusion matrix associated with the second image classifier, wherein the second confusion matrix includes information about correct classification and misclassification levels associated with the second image classifier.

3. The apparatus of claim 1, wherein the processor is further to:
select one of the first, second, and combinational image classifiers; and
classify an image according to a print service provider based on the selected image classifier.

4. The apparatus of claim 3, wherein the processor is further to determine a likelihood of counterfeiting based on at least one of the classified print service provider and the confidence of the classification.

5. The apparatus of claim 1, wherein measuring correct classification and misclassification levels comprises measuring at least one of accuracy and precision of an image classifier.

6. A method, comprising:
creating a first confusion matrix to indicate the confusion of a first image classifier to classify an image based on a first variable data print region type;
creating a second confusion matrix to indicate the confusion of a second image classifier to classify an image based on a second variable data print region type;
determining, by a processor, a weight to associate with the first image classifier and a weight to associate with the second image classifier based on the first and second confusion matrices;
determining a combinational image classifier to classify an image based on the first and second variable print region types according to the determined weights; and
outputting information related to the determined combinational image classifier.

7. The method of claim 6, further comprising:
comparing the precision and accuracy of the first image classifier, the second image classifier, and the combinational image classifier; and
selecting one of the image classifiers based on the comparison.

8. The method of claim 6, further comprising classifying an image with the first and second variable data print region types using the combinational image classifier to determine a source print service provider associated with the image.

9. The method of claim 8, further comprising determining a likelihood of counterfeiting based on a confidence level associated with the classification to the source print service provider.

10. The method of claim 8, further comprising determining a quality level associated with the image based on a confidence level associated with the classification to the source print service provider.

11. The method of claim 6, wherein determining a weight to associate with the first image classifier comprises applying at least one of:
an optimized weighting method; and
a weighting inverse of error rate method.

12. The method of claim 6, further comprising creating an output probability matrix of the confidence level of the first, second, and combinational image classifiers.

13. The method of claim 6, wherein determining the weight o associate with the first image classifier comprises:
determining the accuracy and precision levels associated with the first image classifier.
disregarding a precision level where the precision level is below a threshold; and
determining the weight based on the accuracy level and the remaining precision levels.

14. The method of claim 6, further comprising creating an image classifier based on the first image classifier, the second image classifier, and the combinational image classifier.

15. A machine-readable non-transitory storage medium comprising instructions executable by a processor to:
determine weights of two image region classifiers to create a combinational classifier of the two regions based on confusion matrices related to the two individual image regions; and
classify an image according to a source print service provider based on the combinational classifier; and
output information about the print service provider.

16. The machine-readable non-transitory storage medium of claim 15, further comprising instructions to
determine a confidence level associated with the print service provider classification; and
output information indicating the likelihood of counterfeiting based on the confidence level.

17. The machine-readable non-transitory storage medium of claim 15, further comprising instructions to:
determine a confidence level associated with the print service provider classification; and
output information indicating a quality level associated with the image based on the confidence level.
